(19) United States
(12) Patent Application Publication
(10) Pub. No.: US 2023/0206611 A1
(43) Pub. Date: Jun. 29, 2023

(54) IMAGE PROCESSING DEVICE, AND IMAGE PROCESSING METHOD

(71) Applicant: Fujitsu Limited, Kawaski-shi (JP)

(72) Inventors: Tomonori KUBOTA, Kawasaki (JP); Takanori Nakao, Kawasaki (JP); Yasuyuki Murata, Shizuoka (JP)

(73) Assignee: Fujitsu Limited, Kawaski-shi (JP)

(21) Appl. No.: 18/175,939

(22) Filed: Feb. 28, 2023

Related U.S. Application Data
(63) Continuation of application No. PCT/JP2020/038601, filed on Oct. 13, 2020.

(51) Int. Cl. G06V 10/776; H04N 19/124; G06V 10/22; G06T 7/00; H04N 19/154

(52) U.S. Cl. CPC G06V 10/776; H04N 19/124; G06V 10/22; G06T 7/0002; H04N 19/154; G06T 2207/30168

(57) ABSTRACT

An image processing device includes: a memory; and a processor coupled to the memory and configured to: calculate, in a case where an image quality of image data is changed, recognition accuracy of an object included in each piece of the image data that has been changed; change, in the image data, a region that includes the object to have an image quality with which the recognition accuracy becomes a predetermined allowable limit and to change a region other than the region that includes the object to have an image quality with which the recognition accuracy becomes less than the predetermined allowable limit; and input, into an encoder, the image data that has been changed.

### CROSS-REFERENCE TO RELATED APPLICATION

This application is a continuation application of International Application PCT/JP2020/038601 filed on Oct. 13, 2020 and designated the U.S., the entire contents of which are incorporated herein by reference.

### FIELD

The embodiments discussed herein are related to an image processing device, an image processing method, and an image processing program.

### BACKGROUND

Typically, in a case where image data is recorded or transmitted, compression processing is executed using an encoder or the like, and a data size is reduced, so that reduction in recording cost and transmission cost is achieved.

Japanese Laid-open Patent Publication No. 2017-163223 and Japanese Laid-open Patent Publication No. 2006-93880 are disclosed as related art.

### SUMMARY

According to an aspect of the embodiments, an image processing device includes: a memory; and a processor coupled to the memory and configured to: calculate, in a case where an image quality of image data is changed, recognition accuracy of an object included in each piece of the image data that has been changed; change, in the image data, a region that includes the object to have an image quality with which the recognition accuracy becomes a predetermined allowable limit and to change a region other than the region that includes the object to have an image quality with which the recognition accuracy becomes less than the predetermined allowable limit; and input, into an encoder, the image data that has been changed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a first diagram illustrating an example of a system configuration of a compression processing system;

FIG. 2 is a diagram illustrating an example of a hardware configuration of an image processing device;

FIG. 3 is a first diagram illustrating an example of a functional configuration of the image processing device;

FIG. 4 is a first diagram illustrating a specific example of processing for generating processed image data for each region by the image processing device;

FIG. 5 is a diagram illustrating an example of a functional configuration of an encoder;

FIG. 6 is a first flowchart illustrating a flow of compression processing by a compression processing system;

FIG. 7 is a second flowchart illustrating the flow of the compression processing by the compression processing system;

FIG. 8 is a second diagram illustrating an example of the functional configuration of the image processing device;

FIG. 9 is a third diagram illustrating an example of the functional configuration of the image processing device;

FIG. 10 is a fourth diagram illustrating an example of the functional configuration of the image processing device;

FIG. 11 is a second diagram illustrating the specific example of the processing for generating the processed image data for each region by the image processing device;

FIG. 12 is a third diagram illustrating the specific example of the processing for generating the processed image data for each region by the image processing device;

FIG. 13 is a third flowchart illustrating the flow of the compression processing by the compression processing system;

FIG. 14 is a second diagram illustrating an example of the system configuration of the compression processing system;

FIG. 15 is a fifth diagram illustrating an example of the functional configuration of the image processing device; and

FIG. 16 is a fourth flowchart illustrating the flow of the compression processing by the compression processing system.

### DESCRIPTION OF EMBODIMENTS

On the other hand, in recent years, there have been an increasing number of cases in which image data is recorded or transmitted for the purpose of being utilized for image recognition processing by artificial intelligence (AI). As a representative model of the AI, for example, a model using deep learning or machine learning can be exemplified.

However, typical compression processing is executed based on human visual characteristics and thus is not executed based on motion analysis of the AI. Therefore, there has been a case where the typical compression processing cannot realize a sufficient compression level for a region that is not needed for image recognition processing by the AI.

On the other hand, depending on the type of the encoder, some encoders cannot change the compression level when the compression processing is executed on the image data in region unit. Therefore, in a case where such an encoder is used, even if the region that is not needed for the image recognition processing by the AI can be analyzed, it is not possible to execute the compression processing on the region at a compression level different from that of other regions, and the sufficient compression level cannot be achieved.

In one aspect, an object is to implement compression processing suitable for image recognition processing by the AI.

Hereinafter, each embodiment will be described with reference to the attached drawings. Note that, in the description here and the drawings, components having substantially the same functional configuration are denoted by the same reference numerals, and redundant description is omitted.

[First Embodiment]

<System Configuration of Compression Processing System>

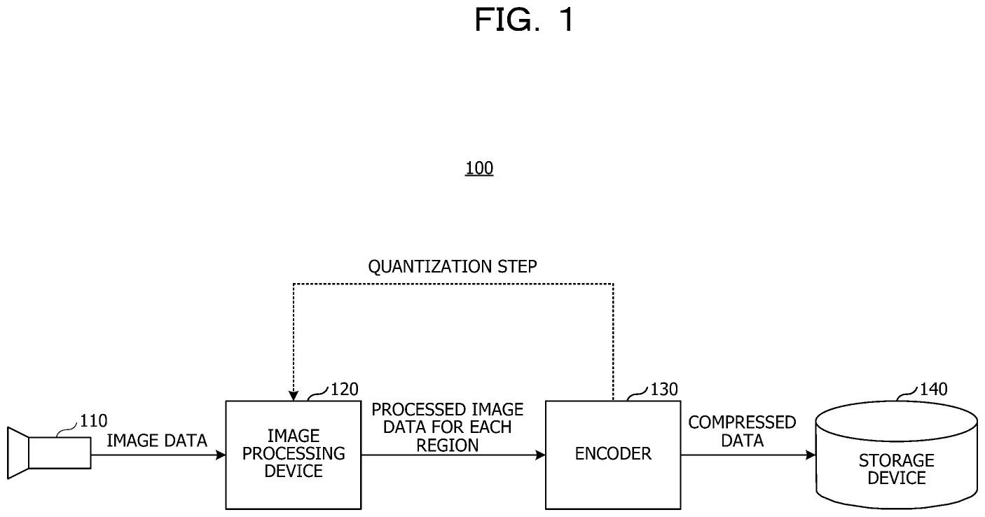

First, a system configuration of an entire compression processing system including an image processing device according to a first embodiment will be described. FIG. 1 is a first diagram illustrating an example of the system configuration of the compression processing system.

As illustrated in FIG. 1, a compression processing system 100 includes an imaging device 110, an image processing device 120, an encoder 130, and a storage device 140.

The imaging device 110 captures an image at a predetermined frame period, and transmits image data to the image processing device 120. Note that it is assumed that the image data include an object to be a target of image recognition processing.

The image processing device 120 includes a trained model that executes the image recognition processing. The image processing device 120 acquires a quantization step set to the encoder 130. Furthermore, while changing the quantization step, the image processing device 120 sequentially executes filter processing on the image data so as to have an image quality equivalent to an image quality of each piece of decoded data corresponding to each piece of compressed data in a case where the encoder 130 executes compression processing.

Furthermore, the image processing device 120 sequentially executes the image recognition processing, using the trained model, on each piece of processed image data generated by sequentially executing the filter processing on the image data and predicts recognition accuracy of each object.

Furthermore, the image processing device 120
extracts a region of the object from the processed image data changed to have an image quality with which the predicted recognition accuracy becomes an allowable limit and
extracts a region other than the object region from the processed image data changed to have an image quality with which the predicted recognition accuracy is less than the allowable limit
so as to generate the processed image data for each region.

Moreover, the image processing device 120 inputs the generated processed image data for each region into the encoder 130.

The encoder 130 notifies the image processing device 120 of the set quantization step. Furthermore, the encoder 130 executes the compression processing on the processed image data for each region input by the image processing device 120 and stores the compressed data in the storage device 140. Note that the encoder 130 executes the compression processing using a uniform quantization step on the input processed image data for each region.

As described above, the image processing device 120 according to the first embodiment generates the processed image data for each region from the image data and inputs the processed image data for each region into the encoder 130 so as to execute encoding processing. As a result, according to the image processing device 120 according to the first embodiment, even in a case where the encoder 130 cannot change the quantization step for each region, compressed data on which the compression processing has been executed at an appropriate compression level for each region is output from the encoder 130. For example, according to the image processing device 120 according to the first embodiment, it is possible to implement compression processing suitable for image recognition processing by the AI.

<Hardware Configurations of Image Processing Device and Encoder>

Next, hardware configurations of the image processing device 120 and the encoder 130 will be described. Note that, since the image processing device 120 and the encoder 130 have a similar hardware configuration, the hardware configuration of the image processing device 120 will be described here.

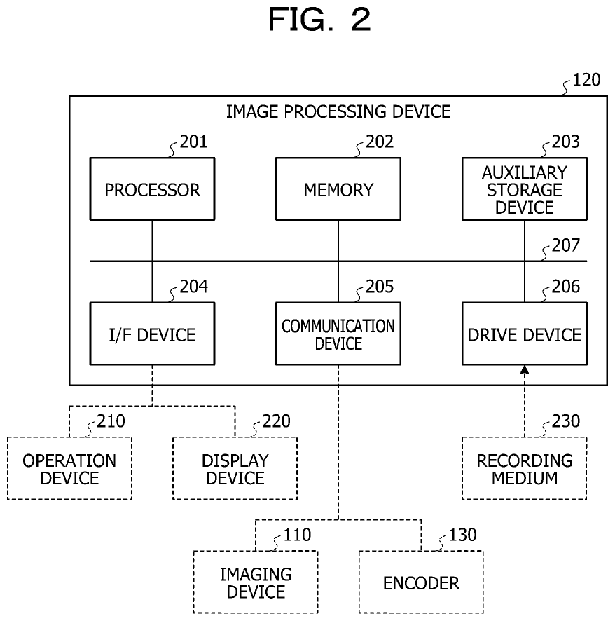

FIG. 2 is a diagram illustrating an example of the hardware configuration of the image processing device. The image processing device 120 includes a processor 201, a memory 202, an auxiliary storage device 203, an interface (I/F) device 204, a communication device 205, and a drive device 206. Note that the pieces of hardware of the image processing device 120 are coupled to each other via a bus 207.

The processor 201 includes various arithmetic devices such as a central processing unit (CPU) or a graphics processing unit (GPU). The processor 201 reads various programs (for example, image processing program to be described later or the like) onto the memory 202 and executes them.

The memory 202 includes a main storage device such as a read only memory (ROM) or a random access memory (RAM). The processor 201 and the memory 202 form a so-called computer. The processor 201 executes various programs read into the memory 202 so as to cause the computer to implement various functions (details of various functions will be described later).

The auxiliary storage device 203 stores various programs and various types of data used when the various programs are executed by the processor 201.

The I/F device 204 is a coupling device that couples the image processing device 120 with an operation device 210 and a display device 220, which are examples of external devices. The I/F device 204 receives an operation on the image processing device 120 via the operation device 210. Furthermore, the I/F device 204 displays a result of processing by the image processing device 120 via the display device 220.

The communication device 205 is a communication device for communicating with another device. In a case of the image processing device 120, communication is performed with the imaging device 110 and the encoder 130 via the communication device 205.

The drive device 206 is a device for setting a recording medium 230. The recording medium 230 mentioned here includes a medium that optically, electrically, or magnetically records information, such as a compact disc read only memory (CD-ROM), a flexible disk, or a magneto-optical disk. Furthermore, the recording medium 230 may include a semiconductor memory or the like that electrically records information, such as a ROM or a flash memory.

Note that the various programs to be installed in the auxiliary storage device 203 are installed, for example, by setting the distributed recording medium 230 in the drive device 206 and reading the various programs recorded in the recording medium 230 by the drive device 206. Alternatively, various programs installed in the auxiliary storage device 203 may be installed by being downloaded from a network via the communication device 205.

<Functional Configuration of Image Processing Device>

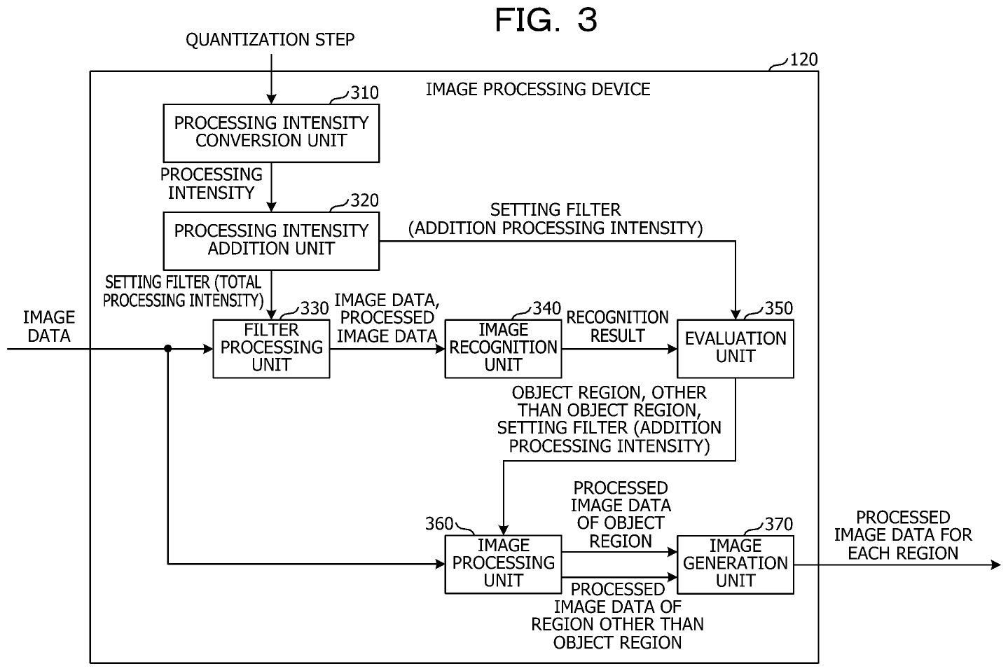

Next, a functional configuration of the image processing device 120 will be described. FIG. 3 is a first diagram illustrating an example of the functional configuration of the image processing device. As described above, the image processing program is installed in the image processing device 120, and by executing the program, the image processing device 120 functions as a processing intensity conversion unit 310 and a processing intensity addition unit 320. Moreover, the image processing device 120 functions as a filter processing unit 330, an image recognition unit 340, an evaluation unit 350, an image processing unit 360, and an image generation unit 370.

The processing intensity conversion unit 310 acquires the quantization step set to the encoder 130 and converts the quantization step into a processing intensity, and then, notifies the processing intensity addition unit 320 of the processing intensity. Note that the “processing intensity” indicates

an intensity of filter processing (filter processing for making image quality of image data be equivalent to image quality of decoded data) for causing a deterioration degree equivalent to a difference (deterioration degree of image quality) between
an image quality of the image data and
an image quality of the decoded data in a case where the encoder 130 executes the compression processing on the image data using the corresponding quantization step and a decoder (not illustrated) executes decoding processing on the compressed data. Note that a granularity of a value of the processing intensity does not need to match a granularity of a value of the quantization step.

The processing intensity addition unit 320 sequentially adds the processing intensity (referred to as “addition processing intensity”) added in a case where the quantization step set to the encoder 130 is sequentially increased over the entire range to the processing intensity notified by the processing intensity conversion unit 310 and calculates each total processing intensity.

Furthermore, the processing intensity addition unit 320 sequentially sets each setting filter corresponding to each calculated total processing intensity to the filter processing unit 330.

Moreover, the processing intensity addition unit 320 sequentially notifies the evaluation unit 350 of each setting filter corresponding to each addition processing intensity.

The filter processing unit 330 notifies the image recognition unit 340 of the input image data. Furthermore, the filter processing unit 330 sequentially executes the filter processing on the input image data, using the setting filter sequentially set by the processing intensity addition unit 320 and sequentially notifies the image recognition unit 340 of each piece of the processed image data.

The image recognition unit 340 is an example of a calculation unit and includes a trained model that executes image recognition processing. The image recognition unit 340 executes the image recognition processing on the image data notified by the filter processing unit 330 and notifies the evaluation unit 350 of a recognition result (including recognition accuracy).

Furthermore, the image recognition unit 340 executes the image recognition processing on the processed image data that is sequentially notified by the filter processing unit 330 and sequentially notifies the evaluation unit 350 of the recognition result.

The evaluation unit 350 specifies a region of an object included in the image data and a region other than the region of the object, based on the recognition result notified by executing the image recognition processing on the image data and notifies the image processing unit 360 of the regions.

Furthermore, the evaluation unit 350 monitors the recognition accuracy of the object included in the recognition result sequentially notified by executing the image recognition processing on each piece of the processed image data and determines whether or not the recognition accuracy of the object is sharply lowered.

Furthermore, the evaluation unit 350 specifies the setting filter (addition processing intensity) notified from the processing intensity addition unit 320, at a timing immediately before when the recognition accuracy is sharply lowered and notifies the image processing unit 360 in association with the object region. Note that the setting filter (addition processing intensity) specified at this time is a setting filter corresponding to an image quality with which recognition accuracy (recognition accuracy for decoded data generated by executing decoding processing on compressed data after compression processing) becomes an allowable limit.

Moreover, the evaluation unit 350 notifies the image processing unit 360 of the setting filter of which the addition processing intensity is maximized in association with the region other than the object region.

The image processing unit 360 executes the filter processing on the image data, by using the setting filter (addition processing intensity) notified by the evaluation unit 350 and generates the processed image data. Furthermore, the image processing unit 360 extracts the object region associated with the setting filter (addition processing intensity) from the generated processed image data, and notifies the image generation unit 370 of the object region.

Furthermore, the image processing unit 360 executes the filter processing on the image data, using the setting filter of which the addition processing intensity is maximized, notified by the evaluation unit 350, and generates the processed image data. Furthermore, the image processing unit 360 extracts the region other than the object region from the generated processed image data and notifies the image generation unit 370 of the extracted region.

The image generation unit 370 is an example of a change unit and combines the processed image data of the object region notified from the image processing unit 360 with the processed image data of the region other than the object region and generates processed image data for each region. Furthermore, the image generation unit 370 inputs the generated processed image data for each region into the encoder 130.

<Specific Example of Processing for Generating Processed Image Data for Each Region>

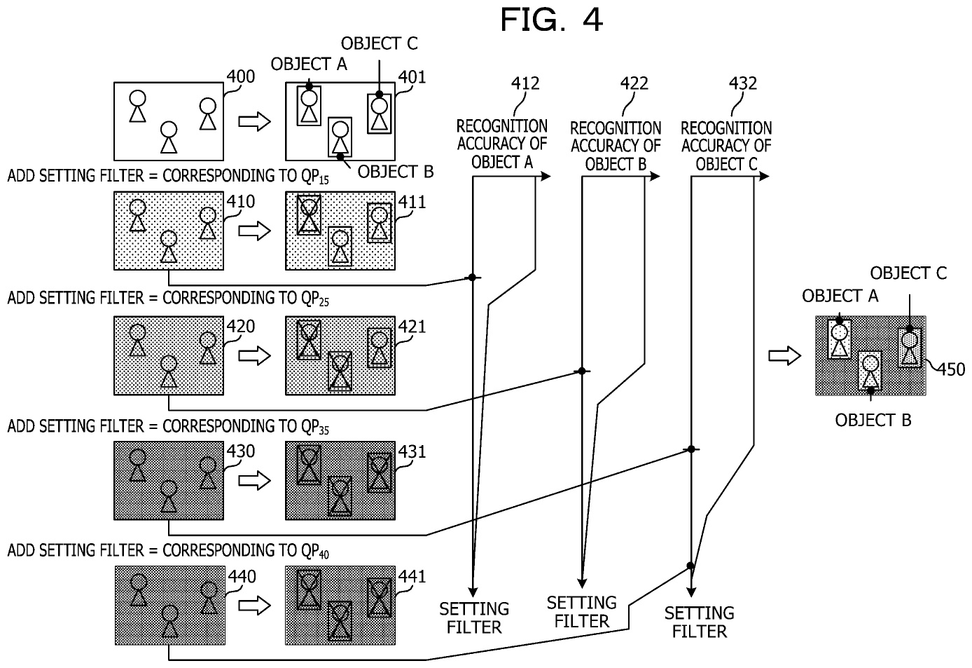

Next, a specific example of processing for generating the processed image data for each region by the image processing device 120 will be described. FIG. 4 is a first diagram illustrating the specific example of the processing for generating the processed image data for each region by the image processing device.

As illustrated in FIG. 4, image data 400 input to the filter processing unit 330 of the image processing device 120 is notified to the image recognition unit 340, and the image recognition processing is executed by the image recognition unit 340. A reference numeral 401 indicates that objects A, B, and C are recognized by executing the image recognition processing on the image data 400.

Furthermore, as described above, in the image processing device 120, the processing intensity conversion unit 310 converts the acquired quantization step into a processing intensity and the processing intensity addition unit 320 sequentially adds the addition processing intensity so as to calculate each total processing intensity. Moreover, in the image processing device 120, the filter processing unit 330 sequentially executes the filter processing on the image data using the setting filter corresponding to each total processing intensity, and the image recognition unit 340 sequentially executes the image recognition processing on each piece of the processed image data.

The example in FIG. 4 indicates that the filter processing is executed on the image data 400 by using a setting filter corresponding to a total processing intensity obtained by adding an addition processing intensity corresponding to QP¹⁵ and processed image data 410 is generated. Furthermore, the example in FIG. 4 indicates that, by executing the image recognition processing on the processed image data 410, a recognition result 411 is output, and recognition accuracy for the object A falls below the allowable limit.

Similarly, the example in FIG. 4 indicates that the filter processing is executed on the image data 400 by using a setting filter corresponding to a total processing intensity obtained by adding an addition processing intensity corresponding to QP₂₅ and processed image data 420 is generated. Furthermore, the example in FIG. 4 indicates that, by executing the image recognition processing on the processed image data 420, a recognition result 421 is output, and recognition accuracy for the object B newly falls below the allowable limit.

Similarly, the example in FIG. 4 indicates that the filter processing is executed on the image data 400 by using a setting filter corresponding to a total processing intensity obtained by adding an addition processing intensity corresponding to QP₃₅ and processed image data 430 is generated. Furthermore, the example in FIG. 4 indicates that, by executing the image recognition processing on the processed image data 430, a recognition result 431 is output, and recognition accuracy for the object C newly falls below the allowable limit.

Moreover, the example in FIG. 4 indicates that the filter processing is executed on the image data 400 by using a setting filter corresponding to a total processing intensity obtained by adding the maximum addition processing intensity corresponding to QP₄₀ and processed image data 440 is generated. Furthermore, the example in FIG. 4 indicates that a recognition result 441 is output by executing the image recognition processing on the processed image data 440.

Furthermore, in FIG. 4, graphs 412, 422, and 432 indicate changes in the recognition accuracy of each object when the filter processing is executed by setting each setting filter to the filter processing unit 330 and the image recognition processing is executed on the processed image data. As indicated in the graphs 412, 422, and 432, the recognition accuracy of each of the objects A to C is sharply lowered at a predetermined setting filter.

For example, in a case of the object A, by setting the setting filter corresponding to the total processing intensity obtained by adding the addition processing intensity corresponding to QP¹⁵, the recognition accuracy is sharply lowered. Similarly, in a case of the object B, by setting the setting filter corresponding to the total processing intensity obtained by adding the addition processing intensity corresponding to QP₂₅, the recognition accuracy is sharply lowered. Similarly, in a case of the object C, by setting the setting filter corresponding to the total processing intensity obtained by adding the addition processing intensity corresponding to QP₃₅, the recognition accuracy is sharply lowered.

Therefore, in a case of the example in FIG. 4, the evaluation unit 350 specifies a setting filter corresponding to QP₁₄ as the setting filter notified at a timing immediately before when the recognition accuracy is sharply lowered and notifies the image processing unit 360 in association with a region of the object A.

Similarly, the evaluation unit 350 specifies a setting filter corresponding to QP₂₄ as the setting filter notified at a timing immediately before when the recognition accuracy is sharply lowered and notifies the image processing unit 360 in association with a region of the object B.

Similarly, the evaluation unit 350 specifies a setting filter corresponding to QP₃₄ as the setting filter notified at a timing immediately before when the recognition accuracy is sharply lowered and notifies the image processing unit 360 in association with a region of the object C.

Moreover, the evaluation unit 350 notifies the image processing unit 360 of a setting filter corresponding to QP₄₀ that is a setting filter of which the addition processing intensity is maximized.

As a result, as illustrated in FIG. 4, the image generation unit 370 generates processed image data 450 for each region obtained by combining
the region of the object A extracted from the processed image data generated by executing the filter processing using the setting filter corresponding to QP₁₄, on the image data 400,
the region of the object B extracted from the processed image data generated by executing the filter processing using the setting filter corresponding to QP₂₄, on the image data 400,
the region of the object C extracted from the processed image data generated by executing the filter processing using the setting filter corresponding to QP₃₄, on the image data 400, and
the region other than the object regions extracted from the processed image data generated by executing the filter processing using the setting filter corresponding to QP₄₀, on the image data 400.

<Functional Configuration of Encoder>

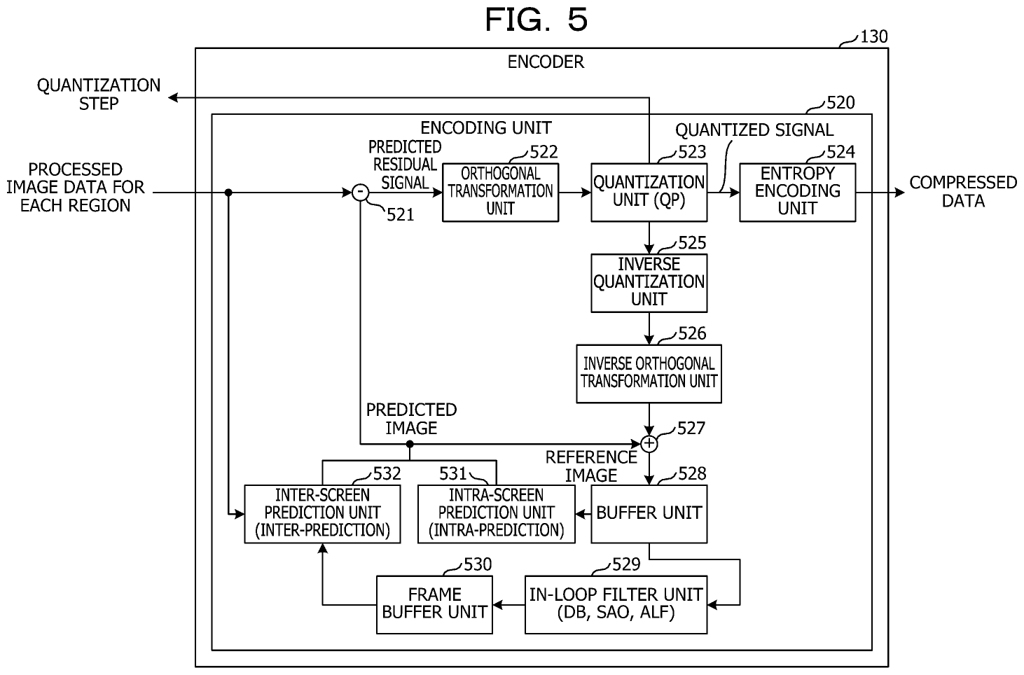

Next, a functional configuration of the encoder 130 will be described. FIG. 5 is a diagram illustrating an example of the functional configuration of the encoder. An encoding program is installed in the encoder 130, and the encoder 130 functions as an encoding unit 520 by executing the program.

The encoding unit 520 includes a difference unit 521, an orthogonal transformation unit 522, a quantization unit 523, an entropy encoding unit 524, an inverse quantization unit 525, and an inverse orthogonal transformation unit 526. Furthermore, the encoding unit 520 includes an addition unit 527, a buffer unit 528, an in-loop filter unit 529, a frame buffer unit 530, an intra-screen prediction unit 531, and an inter-screen prediction unit 532.

The difference unit 521 calculates a difference between the processed image data for each region (for example, processed image data 450 for each region) and predicted image data and outputs a predicted residual signal.

The orthogonal transformation unit 522 executes orthogonal transformation processing on the predicted residual signal output from the difference unit 521.

The quantization unit 523 quantizes the predicted residual signal on which the orthogonal transformation processing has been executed and generates a quantized signal. The quantization unit 523 generates a quantized signal using the set quantization step. Note that the quantization step set to the quantization unit 523 is also notified to the image processing device 120.

The entropy encoding unit 524 generates compressed data by performing entropy encoding processing on the quantized signal.

The inverse quantization unit 525 inverse-quantizes the quantized signal. The inverse orthogonal transformation unit 526 executes inverse orthogonal transformation processing on the quantized signal that has been inverse-quantized.

The addition unit 527 generates reference image data by adding the signal output from the inverse orthogonal transformation unit 526 and the predicted image data. The buffer unit 528 stores the reference image data generated by the addition unit 527.

The in-loop filter unit 529 executes filter processing on the reference image data stored in the buffer unit 528. The in-loop filter unit 529 includes
a deblocking filter (DB),
a sample adaptive offset filter (SAO), and
an adaptive loop filter (ALF).

The frame buffer unit 530 stores the reference image data on which the filter processing has been executed by the in-loop filter unit 529, in frame units.

The intra-screen prediction unit 531 performs inter-screen prediction based on the reference image data and generates the predicted image data. The inter-screen prediction unit 532 performs motion compensation between frames using the input image data (for example, processed image data 450 for each region) and the reference image data and generates the predicted image data.

Note that the predicted image data generated by the intra-screen prediction unit 531 or the inter-screen prediction unit 532 is output to the difference unit 521 and the addition unit 527.

Note that, in the above description, it is assumed that the encoding unit 520 execute the encoding processing using an existing moving image encoding scheme such as MPEG-2, MPEG-4, H. 264, or HEVC. However, the encoding processing by the encoding unit 520 is not limited to these moving image encoding schemes and may be performed using any encoding scheme in which the compression rate is controlled by parameters such as quantization.

<Flow of Compression Processing by Compression Processing System>

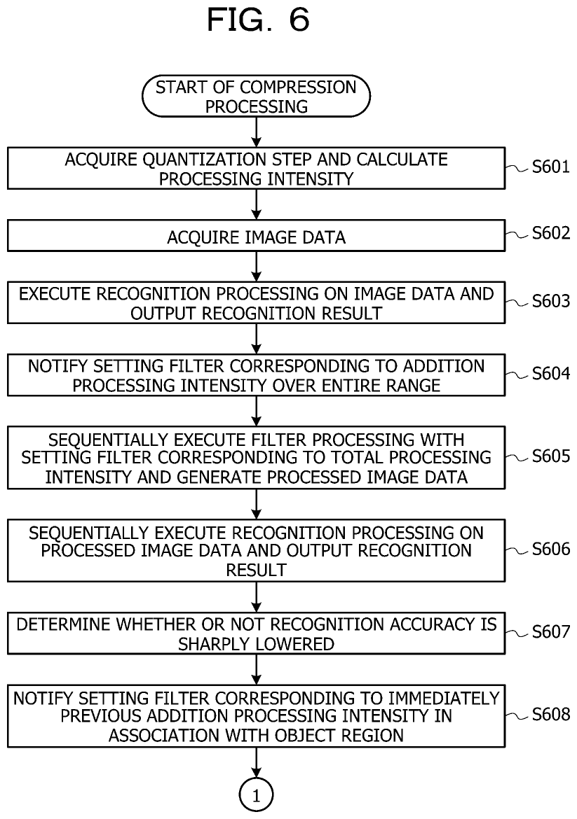

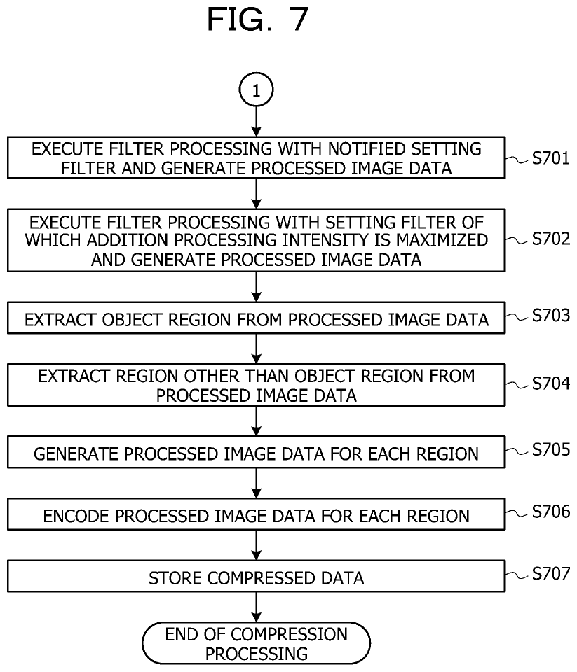

Next, a flow of compression processing by the compression processing system 100 will be described. FIGS. 6 and 7 are first and second flowcharts illustrating an example of the flow of the compression processing by the compression processing system.

In step S601, the processing intensity conversion unit 310 of the image processing device 120 acquires a quantization step by the encoder 130 and calculates a processing intensity corresponding to the acquired quantization step.

In step S602, the filter processing unit 330 of the image processing device 120 acquires image data.

In step S603, the image recognition unit 340 of the image processing device 120 executes the image recognition processing on the image data and outputs a recognition result. Furthermore, the evaluation unit 350 of the image processing device 120 specifies an object region and a region other than the object region.

In step S604, the processing intensity addition unit 320 of the image processing device 120 sequentially notifies the evaluation unit 350 of a setting filter corresponding to an addition processing intensity to be added in a case where the quantization step is increased over the entire range.

In step S605, the processing intensity addition unit 320 of the image processing device 120 calculates each total processing intensity by sequentially adding the addition processing intensity to be added in a case where the quantization step is increased over the entire range to the processing intensity calculated in step S601. Furthermore, the filter processing unit 330 of the image processing device 120 sequentially executes the filter processing on the image data, using a setting filter corresponding to each total processing intensity, and generates each piece of processed image data.

In step S606, the image recognition unit 340 of the image processing device 120 sequentially executes the image recognition processing on each piece of the processed image data and outputs each recognition result.

In step S607, the evaluation unit 350 of the image processing device 120 monitors recognition accuracy of an object included in each recognition result and determines whether or not the recognition accuracy of the object is sharply lowered.

In step S608, the evaluation unit 350 of the image processing device 120 notifies the image processing unit 360 of a setting file corresponding to the addition processing intensity immediately before when the recognition accuracy is sharply lowered, in association with the object region.

Subsequently, in step S701 in FIG. 7, the image processing unit 360 of the image processing device 120 executes the filter processing on the image data, by using the setting filter notified by the evaluation unit 350 and generates the processed image data.

In step S702, the image processing unit 360 of the image processing device 120 executes the filter processing on the image data, by using a setting file of which the addition processing intensity is maximized, and generates the processed image data.

In step S703, the image processing unit 360 of the image processing device 120 extracts the object region from the processed image data generated in step S701.

In step S704, the image processing unit 360 of the image processing device 120 extracts the region other than the object region from the processed image data generated in step S702.

In step S705, the image generation unit 370 of the image processing device 120 generates processed image data for each region, by combining the processed image data of the object region and the region other than the object region extracted in steps S703 and S704.

In step S706, the encoder 130 executes the encoding processing on the processed image data for each region and generates compressed data.

In step S707, the encoder 130 stores the compressed data in the storage device 140.

As is clear from the above description, the image processing device according to the first embodiment sequentially executes the filter processing on the image data using the setting filter corresponding to each total processing intensity, and sequentially executes the image recognition processing on each piece of the generated processed image data. As a result, according to the image processing device according to the first embodiment, it is possible to calculate the recognition accuracy of the object included in each piece of the image data after the change in a case where the image quality of the image data is changed.

Furthermore, the image processing device according to the first embodiment executes the filter processing on the image data by using the setting filter corresponding to the addition processing intensity when the recognition accuracy becomes the predetermined allowable limit and extracts the object region. Furthermore, the image processing device according to the first embodiment executes the filter processing on the image data using the setting filter of which the addition processing intensity is maximized and extracts the region other than the object region. Moreover, the processed image data of the extracted object region and the processed image data of the region other than the object region are combined, and the processed image data for each region is generated. As a result, according to the image processing device according to the first embodiment, it is possible to change the object region of the image data to have an image quality with which the recognition accuracy becomes the predetermined allowable limit, and to change the region other than the object region of the image data to have an image quality with which the recognition accuracy becomes less than the predetermined allowable limit.

Furthermore, the image processing device according to the first embodiment executes the encoding processing by inputting the processed image data for each region into the encoder. As a result, according to the image processing device according to the first embodiment, even in a case where the encoder cannot change the quantization step for each region, the compressed data on which the compression processing is executed at an appropriate compression level for each region is output from the encoder.

For example, according to the image processing device according to the first embodiment, it is possible to implement the compression processing suitable for the image recognition processing by the AI.

[Second Embodiment]

In the first embodiment described above, description has been made as assuming that the region other than the object region is extracted from the processed image data when the filter processing is executed on the image data, by using the setting filter of which the addition processing intensity is maximized.

In contrast, in a second embodiment, a case will be described where invalidated image data (image data in which each pixel of image data is set to zero) is prepared in advance and the region other than the object region is extracted from the invalidated image data. Hereinafter, regarding the second embodiment, differences from the first embodiment described above will be mainly described.

<Functional Configuration of Image Processing Device>

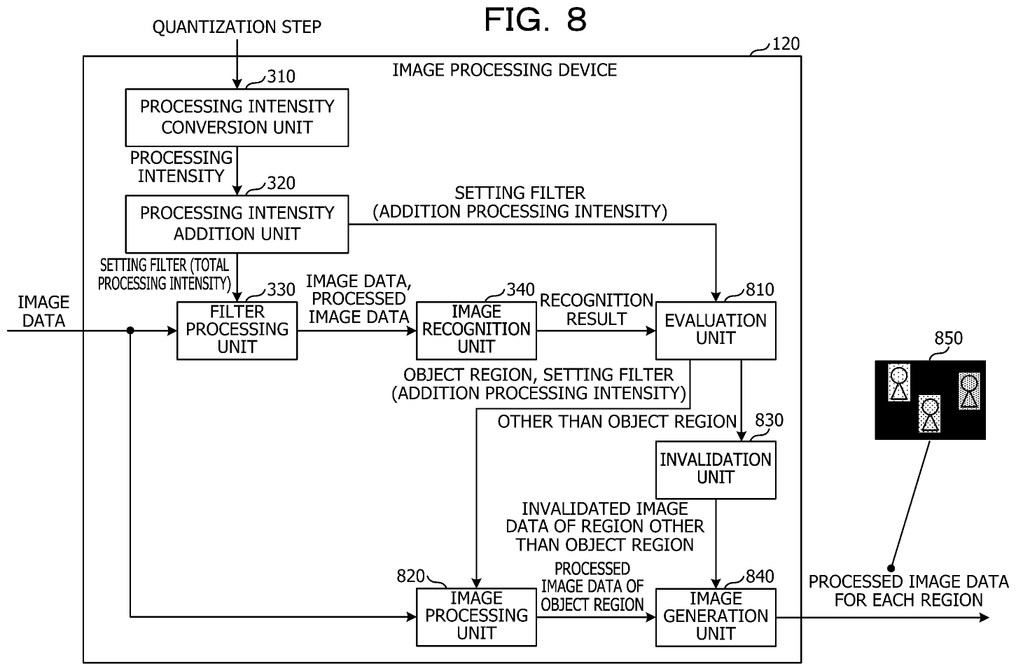

First, a functional configuration of an image processing device 120 according to the second embodiment will be described. FIG. 8 is a second diagram illustrating an example of the functional configuration of the image processing device. The differences from the functional configuration described with reference to FIG. 3 in the first embodiment described above include a point that functions of an evaluation unit 810, an image processing unit 820, an image generation unit 840 are different and an invalidation unit 830 is included.

The evaluation unit 810 specifies a region of an object included in image data, based on a recognition result notified by executing image recognition processing on the image data and notifies the image processing unit 820 of the specified region. Furthermore, the evaluation unit 810 specifies a region other than the region of the object included in the image data, based on the recognition result notified by executing the image recognition processing on the image data and notifies the invalidation unit 830 of the specified region.

Furthermore, the evaluation unit 810 monitors recognition accuracy of the object included in the recognition result sequentially notified by executing the image recognition processing on each piece of processed image data and determines whether or not the recognition accuracy of the object is sharply lowered.

Furthermore, the evaluation unit 810 specifies a setting filter (addition processing intensity) notified from the processing intensity addition unit 320, at a timing immediately before when the recognition accuracy is sharply lowered and notifies the image processing unit 820 of the specified setting filter.

The image processing unit 820 executes the filter processing on the image data, by using the setting filter (addition processing intensity) notified by the evaluation unit 810 and generates the processed image data. Furthermore, the image processing unit 820 extracts the object region notified by the evaluation unit 810 from the processed image data and notifies the image generation unit 840 of the object region.

The invalidation unit 830 includes invalidated image data (image data of which each pixel of image data is set to zero) in advance, extracts a region other than the object region notified by the evaluation unit 810 from the invalidated image data, and notifies the image generation unit 840 of the region.

The image generation unit 840 is another example of a change unit. The image generation unit 840 combines the processed image data of the object region notified from the image processing unit 820 and the invalidated image data of the region other than the object region notified from the invalidation unit 830 and generates processed image data 850 for each region. Furthermore, the image generation unit 840 inputs the generated processed image data 850 for each region into an encoder 130.

<Advantages of Using Invalidated Image Data>

Next, advantages of using the invalidated image data will be described. By generating the processed image data 850 for each region by using the invalidated image data of the region other than the object region, a compression processing system 100 can enjoy the following effects.
In a case where inter-screen prediction is performed by the encoder 130, typically, the encoder 130 derives a difference from image data that is already decodable so as to execute encoding processing. At this time, in a case where the image data that is already decodable includes invalidated image data in the region other than the object region, the difference is not generated. Therefore, it is possible to further reduce a data amount of compressed data (for example, it is possible to improve compression ratio without depending on quantization step).
In a case where the intra-screen prediction is performed by the encoder 130, typically, it is determined how much high-frequency components are left according to the size of the quantization step. At this time, if the invalidated image data is included in the region other than the object region, when the intra-screen prediction is performed, when predicted image data is generated from an adjacent pixel, a difference is extremely smaller than when the predicted image data is generated from an adjacent pixel in a case where an encoding target is not the invalidated image data. Furthermore, in a case of the invalidated image data, there is no high-frequency component. Therefore, it is possible to further reduce a data amount of compressed data (for example, it is possible to improve compression ratio without depending on quantization step).

As is clear from the above description, the image processing device according to the second embodiment sequentially executes the filter processing on the image data using the setting filter corresponding to each total processing intensity, and sequentially executes the image recognition processing on each piece of the generated processed image data. As a result, according to the image processing device according to the second embodiment, it is possible to calculate the recognition accuracy of the object included in each piece of the image data after the change in a case where an image quality of the image data is changed.

Furthermore, the image processing device according to the second embodiment executes the filter processing on the image data by using the setting filter corresponding to the addition processing intensity when the recognition accuracy becomes a predetermined allowable limit and extracts the object region. Furthermore, the image processing device according to the second embodiment extracts the region other than the object region, from the invalidated image data. Moreover, the processed image data of the extracted object region and the invalidated image data of the region other than the object region are combined, and the processed image data for each region is generated. As a result, according to the image processing device according to the second embodiment, it is possible to change the object region of the image data to have an image quality with which the recognition accuracy becomes the predetermined allowable limit, and to change the region other than the object region of the image data to have an image quality with which the recognition accuracy becomes less than the predetermined allowable limit.

Furthermore, the image processing device according to the second embodiment executes the encoding processing by inputting the processed image data for each region into the encoder. As a result, according to the image processing device according to the second embodiment, even in a case where the encoder cannot change the quantization step for each region, the compressed data on which the compression processing is executed at an appropriate compression level for each region is output from the encoder.

For example, according to the image processing device according to the second embodiment, it is possible to implement compression processing suitable for image recognition processing by the AI.

[Third Embodiment]

In the second embodiment described above, the processed image data of the object region and the invalidated image data of the region other than the object region are combined, and the processed image data for each region is generated. On the other hand, in a third embodiment, image data of an object region and an invalidated image data of a region other than the object region are combined, and processed image data for each region is generated. Hereinafter, regarding the third embodiment, differences from the second embodiment described above will be mainly described.

<Functional Configuration of Image Processing Device>

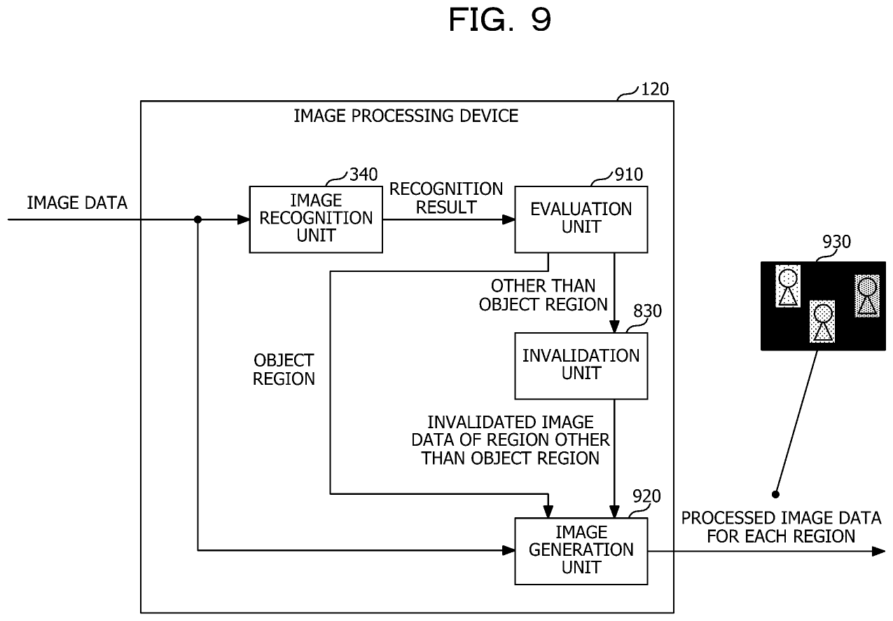

First, a functional configuration of an image processing device 120 according to the third embodiment will be described. FIG. 9 is a third diagram illustrating an example of the functional configuration of the image processing device. Differences from the functional configuration described with reference to FIG. 8 in the second embodiment described above include a point that the processing intensity conversion unit 310, the processing intensity addition unit 320, the filter processing unit 330, and the image processing unit 820 are not included and a point that functions of an evaluation unit 910 and an image generation unit 920 are different.

The evaluation unit 910 is an example of a specification unit and specifies the object region included in image data, based on a recognition result notified by executing image recognition processing on the image data and notifies the image generation unit 920 of the region. Furthermore, the evaluation unit 910 specifies the region other than the region of the object included in the image data, based on the recognition result notified by executing the image recognition processing on the image data and notifies an invalidation unit 830 of the specified region.

An invalidation unit 830 includes invalidated image data (image data of which each pixel of image data is set to zero) in advance, extracts the region other than the object region notified by the evaluation unit 910 from the invalidated image data, and notifies the image generation unit 920 of the region.

The image generation unit 920 is another example of a change unit. The image generation unit 920 extracts the object region notified by the evaluation unit 910 from the image data. Furthermore, the image generation unit 920 combines image data of the extracted object region and invalidated image data of the region other than the object region notified from the invalidation unit 830 and generates processed image data 930 for each region. Furthermore, the image generation unit 920 inputs the generated processed image data 930 for each region into an encoder 130.

As is clear from the above description, the image processing device according to the third embodiment extracts the object region from the image data and extracts the region other than the object region from the invalidated image data. Furthermore, the image processing device according to the third embodiment combines the image data of the extracted object region and the invalidated image data of the region other than the object region and generates the processed image data for each region. Moreover, the image processing device according to the third embodiment executes encoding processing by inputting the processed image data for each region into the encoder.

As a result, according to the image processing device according to the third embodiment, even in a case where the encoder cannot change a quantization step for each region, compressed data on which the compression processing is executed at an appropriate compression level for each region is output from the encoder.

For example, according to the image processing device according to the third embodiment, it is possible to implement compression processing suitable for image recognition processing by the AI.

[Fourth Embodiment]

In the first to third embodiments described above, the processing intensity addition unit has calculated each total processing intensity by sequentially adding the addition processing intensity to be added in a case where the quantization step is increased over the entire range to the processing intensity. On the other hand, when each total processing intensity is calculated by sequentially adding the addition processing intensity to be added in a case where the quantization step is increased over the entire range to the processing intensity and a corresponding setting filter is sequentially set, the number of times of filter processing increases.

Therefore, in a fourth embodiment, by calculating each total processing intensity by sequentially adding only a partial addition processing intensity and setting only the corresponding setting filter, the number of times of filter processing is reduced. For example, in a case where image data to be processed is image data similar to image data that has been already processed (image data including the same object), a timing when recognition accuracy of each object is sharply lowered is estimated in advance in the fourth embodiment. Then, only an addition processing intensity in a specific range according to the estimated timing is sequentially added to the processing intensity, each total processing intensity is calculated, and filter processing is executed using only the corresponding setting filter. As a result, the number of times of the filter processing can be reduced. Hereinafter, regarding the fourth embodiment, differences from the first to third embodiments described above will be mainly described.

<Functional Configuration of Image Processing Device>

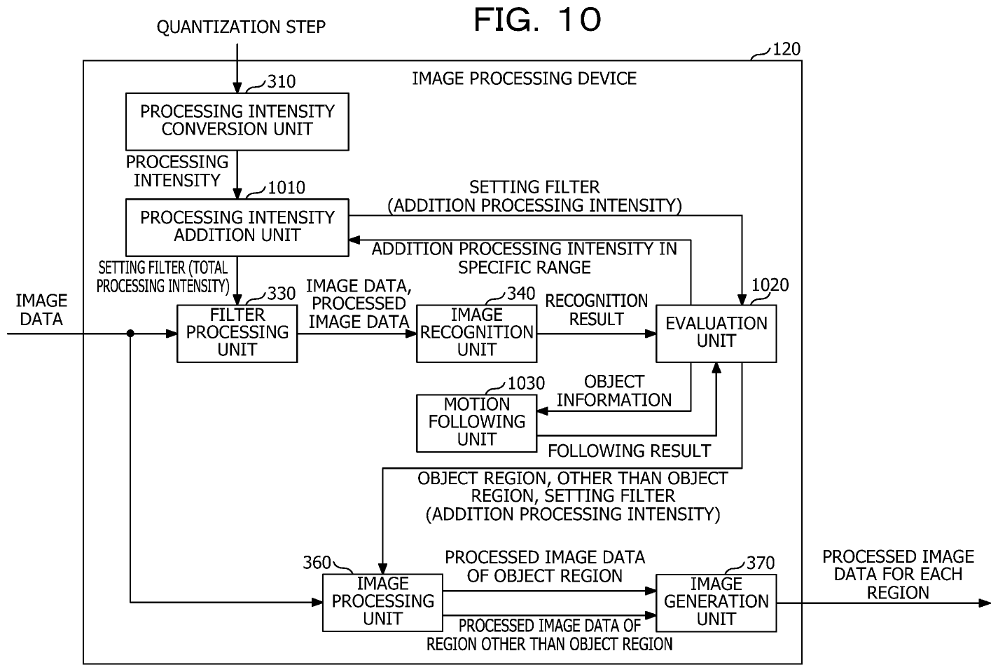

First, a functional configuration of an image processing device 120 according to the fourth embodiment will be described. FIG. 10 is a fourth diagram illustrating an example of the functional configuration of the image processing device. Differences from FIG. 3 include a point that functions of a processing intensity addition unit 1010 and an evaluation unit 1020 are different and a point that a motion following unit 1030 are newly added.

Note that the image processing device 120 illustrated in FIG. 10 has functions similar to those of the image processing device 120 illustrated in FIG. 3, and a function in a case where an object included in image data to be processed is the same as an object included in image data to be processed at previous time is further added. Therefore, hereinafter, the functions added in the fourth embodiment will be described.

The processing intensity addition unit 1010 acquires an addition processing intensity in a specific range that is notified from the evaluation unit 1020 in a case where the image data to be processed is the same as the object included in the image data to be processed at the previous time.

Note that the addition processing intensity in the specific range indicates addition processing intensities before and after the addition processing intensity corresponding to the setting filter notified from the processing intensity addition unit, at a timing immediately before when recognition accuracy of the object sharply changes, when the image data to be processed at the previous time is processed. Therefore, for example, in a case where three objects are included in the image data, three kinds of addition processing intensities in the specific range are notified from the evaluation unit 1020.

Furthermore, the processing intensity addition unit 1010 sequentially adds each of the acquired addition processing intensities in the specific range to the processing intensity notified by a processing intensity conversion unit 310 and calculates each total processing intensity.

Furthermore, the processing intensity addition unit 1010 sequentially notifies a filter processing unit 330 of a setting filter corresponding to each calculated total processing intensity.

The evaluation unit 1020 specifies a region of the object included in the image data to be processed and a region other than the object region, based on a recognition result notified by executing image recognition processing on the image data to be processed and notifies an image processing unit 360 of the regions. Furthermore, the evaluation unit 1020 notifies the motion following unit 1030 of information regarding the object region and acquires a following result from the motion following unit 1030.

Note that the following result is information indicating whether or not an object same as the object included in the image data to be processed is included in the image data to be processed at the previous time.

In a case of receiving the following result indicating that the same object is included from the motion following unit 1030, the evaluation unit 1020 notifies the processing intensity addition unit 1010 of the addition processing intensity in the specific range. For example, when the image recognition processing is executed on the image data to be processed at the previous time, the evaluation unit 1020 specifies a setting filter (addition processing intensity) notified from the processing intensity addition unit 1010, at a timing immediately before when the recognition accuracy is sharply lowered. Then, the evaluation unit 1020 notifies the processing intensity addition unit 1010 of the addition processing intensity in the specific range, by designating addition processing intensities before and after the addition processing intensity corresponding to the specified setting filter.

Furthermore, the evaluation unit 1020 monitors the recognition accuracy of the object included in the recognition result that is sequentially notified from the image recognition unit 340, according to that the addition processing intensity in the specific range is notified, and determines whether or not the recognition accuracy of the object is sharply changed.

Furthermore, the evaluation unit 1020 specifies a setting filter (addition processing intensity) corresponding to a timing immediately before when the recognition accuracy is sharply lowered, and notifies the image processing unit 360 in association with the object region.

The motion following unit 1030 compares the object region in the image data to be processed, notified from the evaluation unit 1020 with the object region in the image data to be processed at the previous time.

Furthermore, in a case of determining that the objects match as a result of the comparison, the motion following unit 1030 notifies the evaluation unit 1020 of the following result indicating that the same object is included.

Furthermore, in a case of determining that the objects do not match as the result of the comparison, the motion following unit 1030 notifies the evaluation unit 1020 of the following result indicating that the same object is not included.

<Specific Example of Processing for Generating Processed Image Data for Each Region>

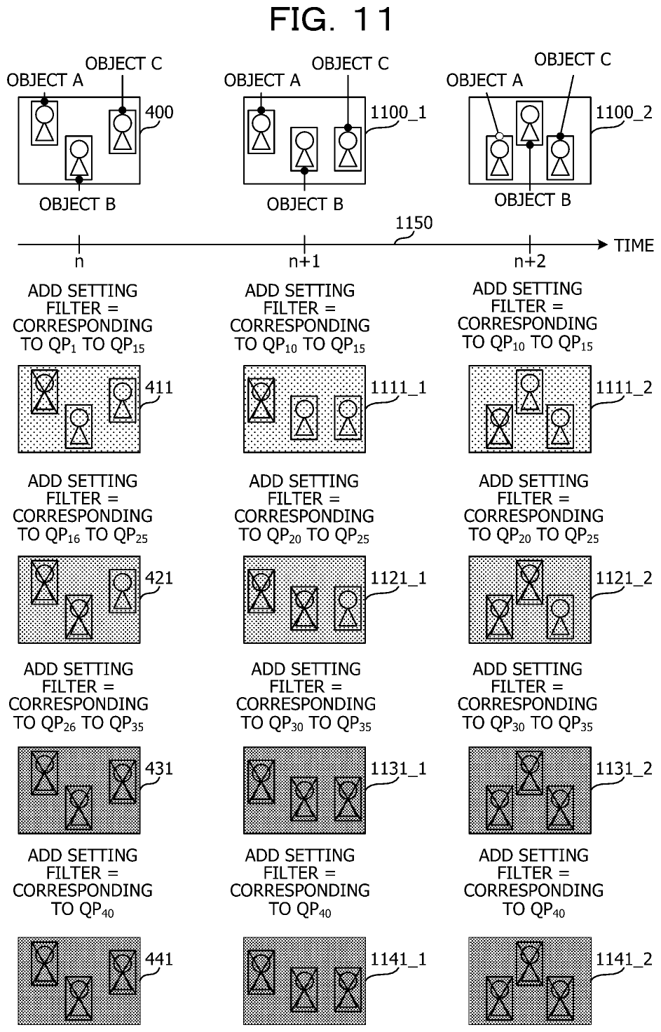

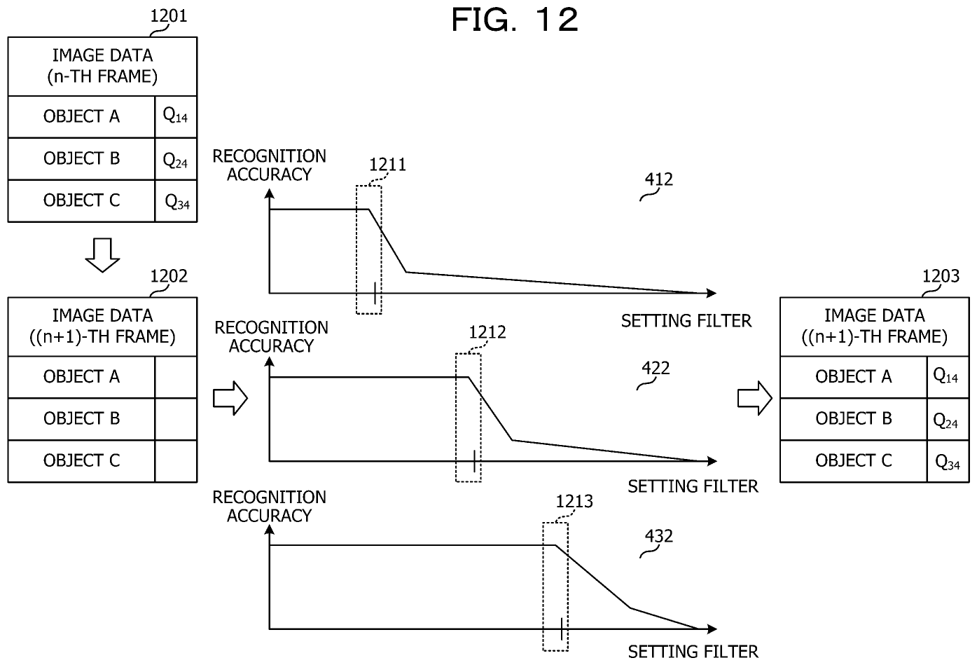

Next, a specific example of processing for generating processed image data for each region by the image processing device 120 according to the fourth embodiment will be described with reference to FIGS. 11 and 12. FIGS. 11 and 12 are second and third diagrams illustrating the specific example of the processing for generating the processed image data for each region by the image processing device.

In FIG. 11, an axis 1150 is a time axis and indicates a state where three consecutive pieces of image data (image data 400, 1100_1, and 1100_2) are input at respective times.

As illustrated in FIG. 11, it is assumed that the image data 400 include three objects (objects A to C), and the image data 1100_1 and 1100_2 include the same objects.

Furthermore, as illustrated in FIG. 11, in a case where the image data 400 is image data to be processed, it is indicated that
in a process for sequentially adding addition processing intensities corresponding to QP₁ to QP₁₅, as a setting filter (addition processing intensity) when the recognition accuracy for the object A becomes an allowable limit, a setting filter (addition processing intensity) corresponding to QP₁₄ is determined,
in a process for sequentially adding addition processing intensities corresponding to QP₁₆ to QP₂₅, as a setting filter (addition processing intensity) when the recognition accuracy for the object B becomes an allowable limit, a setting filter (addition processing intensity) corresponding to QP₂₄ is determined, and
in a process for sequentially adding addition processing intensities corresponding to QP₂₆ to QP₃₅, as a setting filter (addition processing intensity) when the recognition accuracy for the object C becomes an allowable limit, a setting filter (addition processing intensity) corresponding to QP₃₄ is determined. Note that, in FIG. 12, a reference numeral 1201 indicates each setting filter (addition processing intensity) used when the image processing unit 360 executes the filter processing on the image data 400.

On the other hand, in a case where the image data 1100_1 is the image data to be processed, it is indicated that
in a process for sequentially adding the addition processing intensities in the specific range (addition processing intensities corresponding to QP₁₀ to QP₁₅) (dotted line rectangle 1211 in FIG. 12), as the setting filter when the recognition accuracy for the object A becomes the allowable limit, a setting filter corresponding to QP₁₄ is determined,
in a process for sequentially adding the addition processing intensities in the specific range (addition processing intensities corresponding to QP₂₀ to QP₂₅) (dotted line rectangle 1212 in FIG. 12), as the setting filter when the recognition accuracy for the object B becomes the allowable limit, a setting filter corresponding to QP₂₄ is determined, and
in a process for sequentially adding the addition processing intensities in the specific range (addition processing intensities corresponding to QP₃₀ to QP₃₅) (dotted line rectangle 1213 in FIG. 12), as the setting filter when the recognition accuracy for the object C becomes the allowable limit, a setting filter corresponding to QP₃₄ is determined. Note that, in FIG. 12, a reference numeral 1202 indicates a state before the setting filter (addition processing intensity) is determined when the image processing unit 360 executes the filter processing on the image data 1100_1. On the other hand, a reference numeral 1203 indicates a state after the determination.

Similarly, in a case where the image data 1100_2 is the image data to be processed, it is indicated that
in a process for sequentially adding the addition processing intensities in the specific range (addition processing intensities corresponding to QP₁₀ to QP¹⁵), as the setting filter when the recognition accuracy for the object A becomes the allowable limit, the setting filter corresponding to QP₁₄ is determined,
in a process for sequentially adding the addition processing intensities in the specific range (addition processing intensities corresponding to QP₂₀ to QP₂₅), as the setting filter when the recognition accuracy for the object B becomes the allowable limit, the setting filter corresponding to QP₂₄ is determined, and
in a process for sequentially adding the addition processing intensities in the specific range (addition processing intensities corresponding to QP₃₀ to QP₃₅), as the setting filter when the recognition accuracy for the object C becomes the allowable limit, the setting filter corresponding to QP₃₄ is determined.

In this way, according to the fourth embodiment, since the processing intensity addition unit calculates each total processing intensity by sequentially adding only some addition processing intensities, the number of times of filter processing can be largely reduced.

<Flow of Compression Processing by Compression Processing System>

Next, a flow of compression processing by a compression processing system 100 according to the fourth embodiment will be described.

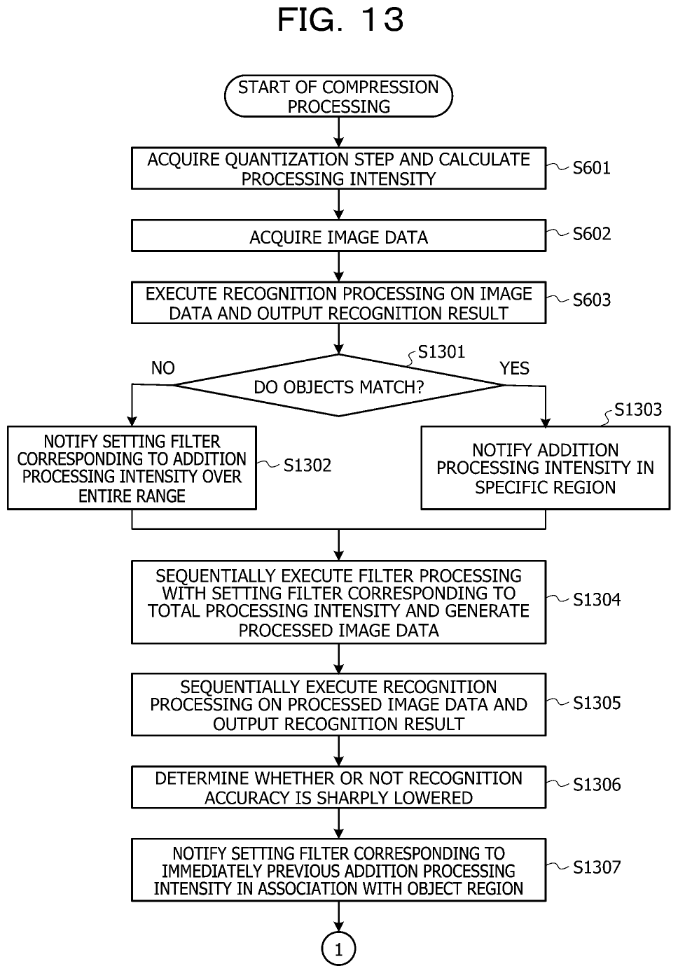

FIG. 13 is a third flowchart illustrating an example of the flow of the compression processing by the compression processing system. Differences from the first flowchart illustrated in FIG. 6 are steps S1301 to S1307.

In step S1301, the motion following unit 1030 of the image processing device 120 determines whether or not the object included in the image data to be processed matches the object included in the image data to be processed at the previous time.

In step S1301, in a case where it is determined that the objects do not match (in a case of NO in step S1301), the procedure proceeds to step S1302.

In step S1302, the processing intensity addition unit 1010 of the image processing device 120 sequentially notifies the evaluation unit 1020 of a setting filter corresponding to an addition processing intensity to be added in a case where the quantization step is increased over the entire range.

In step S1304, the processing intensity addition unit 1010 of the image processing device 120 calculates each total processing intensity by sequentially adding an addition processing intensity to be added in a case where the quantization step is increased over an entire range to a processing intensity. Furthermore, the filter processing unit 330 of the image processing device 120 sequentially executes the filter processing on the image data, using a setting filter corresponding to each total processing intensity, and generates each piece of processed image data.

In step S1305, the image recognition unit 340 of the image processing device 120 sequentially executes the image recognition processing on each piece of the processed image data and outputs each recognition result.

In step S1306, the evaluation unit 1020 of the image processing device 120 monitors recognition accuracy of an object included in each recognition result and determines whether or not the recognition accuracy of the object is sharply lowered.

In step S1307, the evaluation unit 1020 of the image processing device 120 notifies the image processing unit 360 of a setting file corresponding to the addition processing intensity immediately before when the recognition accuracy is sharply lowered, in association with the object region. Thereafter, the procedure proceeds to FIG. 7.

On the other hand, in step S1301, in a case where it is determined that the objects match (in a case of YES in step S1301), the procedure proceeds to step S1303.

In step S1303, the evaluation unit 1020 of the image processing device 120 notifies the processing intensity addition unit 1010 of the addition processing intensity in the specific range.

In step S1304, the processing intensity addition unit 1010 of the image processing device 120 calculates each total processing intensity by sequentially adding the addition processing intensity in the specific range to the processing intensity. Furthermore, the filter processing unit 330 of the image processing device 120 sequentially executes the filter processing on the image data, using a setting filter corresponding to each total processing intensity, and generates each piece of processed image data.

In step S1305, the image recognition unit 340 of the image processing device 120 sequentially executes the image recognition processing on each piece of the processed image data and outputs each recognition result.

In step S1306, the evaluation unit 1020 of the image processing device 120 monitors recognition accuracy of an object included in each recognition accuracy and determines whether or not the recognition accuracy of the object is sharply lowered.

In step S1307, the evaluation unit 1020 of the image processing device 120 notifies the image processing unit 360 of a setting filter corresponding to the addition processing intensity immediately before when the recognition accuracy is sharply lowered, in association with the object region. Thereafter, the procedure proceeds to FIG. 7.

As is clear from the above description, the image processing device according to the fourth embodiment sequentially executes the filter processing on the image data, by using the setting filter corresponding to each total processing intensity obtained by adding the addition processing intensity in the specific range. Furthermore, the image processing device according to the fourth embodiment sequentially executes the image recognition processing on each piece of the generated processed image data. As a result, according to the image processing device according to the fourth embodiment, the recognition accuracy of the object included in each piece of the image data after a change in a case where the image quality of the image data is changed in the specific range can be calculated.

As a result, according to the image processing device according to the fourth embodiment, effects similar to those of the first embodiment described above can be enjoyed, and the number of times of filter processing can be reduced.

[Fifth Embodiment]

In the first to the fourth embodiments described above, a case has been described where the compressed data on which the encoding processing has been executed by the encoder 130 is stored in the storage device 140. Whereas, in the fourth embodiment, the compressed data on which the encoding processing has been executed by the encoder 130 is transmitted to a decoder via a network.

Note that, in a case where the compressed data on which the encoding processing has been executed by the encoder 130 is transmitted to the decoder, a compression processing system controls a bit rate and changes a quantization step so that an overflow does not occur in a virtual buffer.

On the other hand, in a case where the quantization step is changed and the encoding processing is executed using the changed quantization step, it is considered that recognition accuracy of the decoded data on which decoding processing has been executed by the decoder falls below an allowable limit. Therefore, in the fifth embodiment, in a case where there is a possibility that the quantization step is changed by the encoder 130, it is evaluated whether or not the change of the quantization step is appropriate, from the viewpoint of the recognition accuracy. Hereinafter, regarding the fifth embodiment, differences from the first to the fourth embodiments described above will be mainly described.

<System Configuration of Compression Processing System>

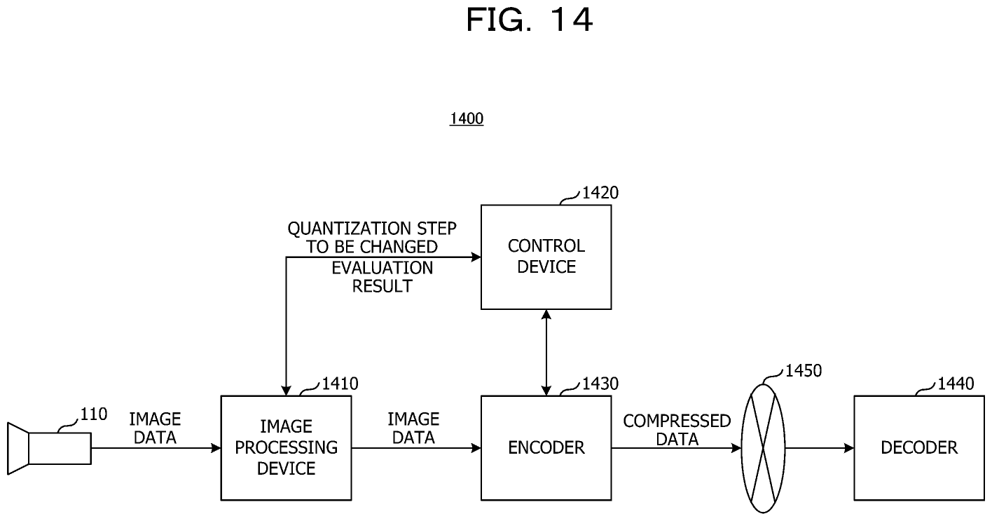

First, a system configuration of an entire compression processing system including an image processing device according to the fifth embodiment will be described. FIG. 14 is a second diagram illustrating an example of the system configuration of the compression processing system.

As illustrated in FIG. 14, a compression processing system 1400 includes an imaging device 110, an image processing device 1410, a control device 1420, an encoder 1430, and a decoder 1440. Note that the encoder 1430 and the decoder 1440 are communicably coupled via a network 1450.

Among these, the imaging device 110 has been described in the first embodiment described above with reference to FIG. 1. Therefore, description is omitted here.

The image processing device 1410 includes a trained model that executes image recognition processing. The image processing device 1410 notifies the encoder 1430 of image data transmitted from the imaging device 110. Furthermore, the image processing device 1410 acquires a quantization step to be changed, from the control device 1420, and evaluates an image quality of decoded data in a case where the encoder 1430 executes encoding processing on the image data using the quantization step. Furthermore, the image processing device 1410 notifies the control device 1420 of an evaluation result.

When the compressed data on which the encoding processing has been executed by the encoder 1430 is transmitted to the decoder, the control device 1420 controls a bit rate. The control device 1420 receives information needed for bit rate control from the encoder 1430 and calculates a quantization step (quantization step for avoiding occurrence of overflow in virtual buffer). Furthermore, the calculated quantization step is notified to the image processing device 1410, and the evaluation result is acquired from the image processing device 1410. Furthermore, the control device 1420 sets the quantization step according to the acquired evaluation result to the encoder 1430.

The encoder 1430 executes the encoding processing using the quantization step set by the control device 1420, on the image data notified by the image processing device 1410, and generates compressed data. Furthermore, the encoder 1430 transmits the generated compressed data to the decoder 1440 via the network 1450.

The decoder 1440 executes the decoding processing on the compressed data transmitted from the encoder 1430 and generates decoded data.

<Functional Configuration of Image Processing Device>

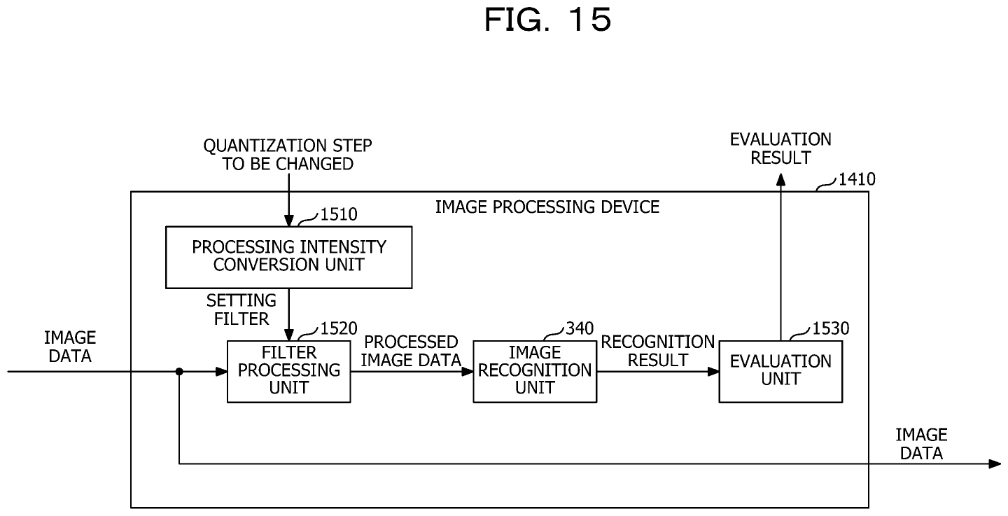

Next, a functional configuration of the image processing device 1410 according to the fifth embodiment will be described. FIG. 15 is a fifth diagram illustrating an example of the functional configuration of the image processing device. As illustrated in FIG. 15, the image processing device 1410 functions as a processing intensity conversion unit 1510, a filter processing unit 1520, an image recognition unit 340, and an evaluation unit 1530.

The processing intensity conversion unit 1510 acquires a quantization step to be changed notified by the control device 1420 and converts the quantization step into a processing intensity. Furthermore, the processing intensity conversion unit 1510 notifies the filter processing unit 1520 of a setting filter corresponding to the processing intensity.

The filter processing unit 1520 executes the filter processing on image data, by using the setting filter notified by the processing intensity conversion unit 1510 and notifies the image recognition unit 340 of processed image data.

Since the image recognition unit 340 has been described in the first embodiment described above with reference to FIG. 3, description thereof is omitted here.

The evaluation unit 1530 determines whether or not recognition accuracy of an object included in the image data is equal to or more than a predetermined allowable limit, based on a recognition result notified by executing the image recognition processing on the processed image data.

Furthermore, in a case of determining that the recognition accuracy is equal to or more than the predetermined allowable limit, the evaluation unit 1530 notifies the control device 1420 of an evaluation result indicating that the recognition accuracy equal to or more than the predetermined allowable limit can be obtained even if the quantization step to be changed is applied.

Furthermore, in a case of determining that the recognition accuracy is less than the predetermined allowable limit, the evaluation unit 1530 notifies the control device 1420 of an evaluation result indicating that the recognition accuracy equal to or more than the allowable limit cannot be obtained in a case where the quantization step to be changed is applied.

<Flow of Compression Processing by Compression Processing System>

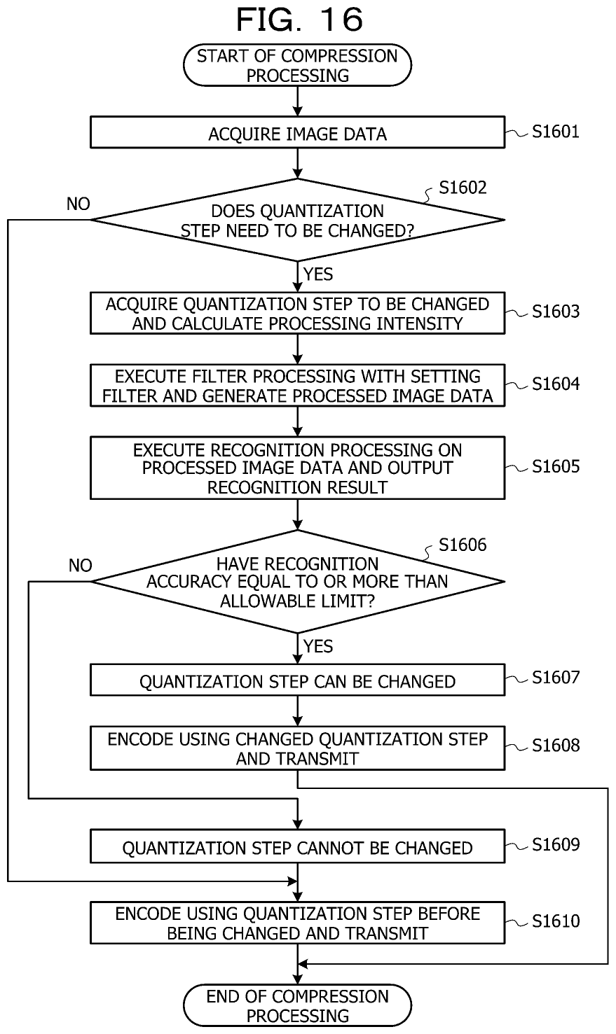

Next, a flow of compression processing by the compression processing system 1400 will be described. FIG. 16 is a fourth flowchart illustrating an example of the flow of the compression processing by the compression processing system.

In step S1601, the filter processing unit 1520 of the image processing device 1410 acquires image data.

In step S1602, the processing intensity conversion unit 1510 of the image processing device 1410 determines whether or not the quantization step needs to be changed, by determining whether or not the quantization step to be changed is notified by the control device 1420.

In a case where the quantization step to be changed is not notified in step S1602, it is determined that the quantization step does not need to be changed (determine as NO in step S1602), and the procedure proceeds to step S1610.

On the other hand, in a case where the quantization step to be changed is notified in step S1602, it is determined that the quantization step needs to be changed (determine as YES in step S1602), the procedure proceeds to step S1603.

In step S1603, the processing intensity conversion unit 1510 of the image processing device 1410 acquires the quantization step to be changed and calculates a processing intensity. Furthermore, the processing intensity conversion unit 1510 notifies the filter processing unit 1520 of a setting filter corresponding to the calculated processing intensity.

In step S1604, the filter processing unit 1520 of the image processing device 1410 executes the filter processing on the image data by using the notified setting filter and generates processed image data.

In step S1605, the image recognition unit 340 of the image processing device 1410 executes the image recognition processing on the generated processed image data and outputs a recognition result.

In step S1606, the evaluation unit 1530 of the image processing device 1410 determines whether or not the output recognition result has recognition accuracy equal to or more than the predetermined allowable limit.

In a case where it is determined in step S1606 that the recognition accuracy equal to or more than the predetermined allowable limit is not included (in a case of NO in step S1606), the procedure proceeds to step S1609.

On the other hand, in a case where it is determined in step S1606 that the recognition accuracy equal to or more than the predetermined allowable limit is included (in a case of YES in step S1606), the procedure proceeds to step S1607.

In step S1607, the evaluation unit 1530 of the image processing device 1410 evaluates that the quantization step can be changed and notifies the control device 1420 of the evaluation result.

In step S1608, the control device 1420 notifies the encoder 1430 of the changed quantization step that has been changed to the quantization step to be changed. Furthermore, the encoder 1430 executes the encoding processing using the quantization step notified by the control device 1420 and transmits compressed data to the decoder 1440.

In step S1609, the evaluation unit 1530 of the image processing device 1410 evaluates that it is not possible to change the quantization step, and notifies the control device 1420 of the evaluation result.

In step S1610, the control device 1420 notifies the encoder 1430 of the quantization step before being changed. Furthermore, the encoder 1430 executes the encoding processing using the quantization step before being changed and transmits the compressed data to the decoder 1440.

As is clear from the above description, in the compression processing system according to the fifth embodiment, in a case where a possibility for changing the quantization step by the encoder is caused, the image processing device evaluates whether or not the quantization step can be changed, from the viewpoint of the recognition accuracy of the decoded data. Furthermore, the compression processing system according to the fifth embodiment executes the encoding processing by the encoder with the quantization step according to the evaluation result by the image processing device.

As a result, according to the fifth embodiment, it is possible to implement compression processing suitable for image recognition processing by the AI.

Note that, in the fifth embodiment described above, description has been made as assuming that the image processing device 1410 notifies the encoder 1430 of the acquired image data. However, as in the first to the fourth embodiments described above, the image processing device 1410 may generate the processed image data from the acquired image data and notify the encoder 1430 of the generated processed image data.

[Other Embodiments]

In each embodiment described above, the region including the object in the image data is specified as the object region. However, a method for specifying the object region is not limited to this. For example, a region including the region including the object and a region around the region including the object may be specified as the object region.

Furthermore, in each embodiment described above, it has been described as assuming that the processing intensity addition unit specifies the setting filter corresponding to the total processing intensity and the filter processing unit executes the filter processing so as to change the image quality of the image data. However, a method for changing the image quality of the image data is not limited to this.

For example, by statistically obtaining a relationship between the quantization step and the setting filter in advance, the setting filter may be specified. Furthermore, the relationship between the quantization step and the setting filter may be obtained, for example, by training
decoded data when the decoding processing is executed on the compressed data on which the encoding processing has been executed by using the quantization step and
processed image data when the filter processing has been executed on the image data by using the setting filter. At that time, an image quality of the decoded data and an image quality of the processed image data may be evaluated, for example, using an index such as a peak signal to noise ratio (PSNR) or a structural similarity (SSIM).

Furthermore, in each embodiment described above, the image processing device and the encoder are separated. However, the image processing device and the encoder may be configured as an integrated device.

Note that the present embodiment is not limited to the configurations described here and may include, for example, combinations of the configurations or the like described in the above embodiments and other elements. These points may be changed without departing from the spirit of the embodiments and may be appropriately assigned according to application modes thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image processing device comprising:
a memory; and
a processor coupled to the memory and configured to:
calculate, in a case where an image quality of image data is changed, recognition accuracy of an object included in each piece of the image data that has been changed;
change, in the image data, a region that includes the object to have an image quality with which the recognition accuracy becomes a predetermined allowable limit and to change a region other than the region that includes the object to have an image quality with which the recognition accuracy becomes less than the predetermined allowable limit; and
inputs, into an encoder, the image data that has been changed.

2. The image processing device according to claim 1, wherein the region that includes the object is specified, based on a recognition result in a case where image recognition processing is executed on the image data.

3. The image processing device according to claim 2, wherein the processor changes, in the image data, the region other than the region that includes the object to have a predetermined image quality.

4. The image processing device according to claim 2, wherein the processor invalidates, in the image data, the region other than the region that includes the object.

5. The image processing device according to claim 1, wherein the processor evaluates the image quality with which the recognition accuracy becomes the predetermined allowable limit, based on a change in the recognition accuracy, in a case where the image quality of the image data is changed in a specific range.

6. The image processing device according to claim 5, wherein, in a case where the object included in the image data is the same as an object included in image data of which an image quality has been already changed, the processor evaluates the image quality with which the recognition accuracy becomes the predetermined allowable limit, based on a change in the recognition accuracy, in a case where the image quality is changed in the specific range according to the predetermined allowable limit.

7. The image processing device according to claim 5, wherein
in a case where information regarding a quantization step to be changed is acquired from a control device that controls a quantization step used by the encoder, the processor calculates, in a case where an image quality of image data is changed based on the information regarding the quantization step, recognition accuracy of an object included in the image data that has been changed, and
the processor notifies the control device of an evaluation result that indicates whether or not the calculated recognition accuracy is equal to or more than the predetermined allowable limit.

8. An image processing device comprising:
a memory; and
a processor coupled to the memory and configured to:
specify, in image data, a region that includes an object and a region other than the region that includes the object, based on a recognition result in a case where image recognition processing is executed on the image data;
invalidate, in the image data, the region other than the region that includes the object; and
input, into an encoder, image data in which the region other than the region that includes the object is invalidated.

9. An image processing method comprising:
calculating, in a case where an image quality of image data is changed, recognition accuracy of an object included in each piece of the image data that has been changed;
changing, in the image data, a region that includes the object to have an image quality with which the recognition accuracy becomes a predetermined allowable limit and to change a region other than the region that includes the object to have an image quality with which the recognition accuracy becomes less than the predetermined allowable limit; and
inputting, into an encoder, the image data that has been changed.
